(19) United States
(12) Patent Application Publication
(10) Pub. No.: US 2025/0347157 A1
(43) Pub. Date: Nov. 13, 2025

(54) DOOR ASSEMBLY FOR A VEHICLE

(71) Applicant: MAGNA INTERNATIONAL INC., Aurora (CA)

(72) Inventors: Ian PATTERSON, Novi, MI (US); Venugopal GARIMELLA, Troy, MI (US); Shrikanth GUJJAL, Rochester Hills, MI (US); Patrick M. HARNEY, Rochester, MI (US); Joseph SALMAN, West Bloomfield, MI (US); Hemant BARGE, Troy, MI (US); Chandra GANJI, Rochester Hills, MI (US); Steven CIZMAS, Clinton Township, MI (US); Shambhu Ramchandra TELI, Pune (IN); Pritish Vilas KHUTAL, Pune (IN)

(21) Appl. No.: 19/198,557

(22) Filed: May 5, 2025

Related U.S. Application Data
(60) Provisional application No. 63/643,600, filed on May 7, 2024.

(51) Int. Cl. E05B 83/38; B60J 5/04; B62D 25/04; E05B 85/04

(52) U.S. Cl. CPC E05B 83/38; B62D 25/04; E05B 85/04; B60J 5/0479

(57) ABSTRACT

A door assembly for a vehicle includes a body that has an A pillar, a C pillar, a cant rail extending between a top of the A pillar and a top of the C pillar, and a rocker rail that extends between a bottom of the A pillar and a bottom of the C pillar. A front door is moveably connected to the A pillar along a front connector, and has a front B pillar region spaced from the front connector. A rear door is moveably connected to the C pillar along a rear connector, and has a rear B pillar region spaced from the rear connector. The front and rear doors are moveable into a closed position in which the front B pillar region of the front door and the rear B pillar region of the rear door overlie one another to close the body.

### CROSS REFERENCE TO RELATED APPLICATIONS

This U.S. Non-Provisional Patent Application claims the benefit of and priority to U.S. Provisional Patent Application Ser. No. 63/643,600 filed May 7, 2024 entitled “DOOR ASSEMBLY FOR A VEHICLE”, the entire disclosure of which is incorporated herein by reference in its entirety.

### BACKGROUND OF THE DISCLOSURE

### 1. Field of the Disclosure

The present disclosure relates to door assemblies for vehicles, such as automobiles. More particularly, the present disclosure relates to a latch and hinge system for a coach style door assembly for vehicles.

### 2. Related Art

This section provides background information related to the present disclosure which is not necessarily prior art.

Sedan and sport utility vehicle style automobiles typically include an arrangement of front and rear doors which permit users to access front and rear seats of the vehicle. Each of the doors are pivotable along a hinge. The doors also each have a latch assembly that is configured to engage a striker that is mounted on the body of the vehicle to selectively secure the door in a closed position. The striker associated with each front door is typically mounted to a B pillar of the body of the vehicle, while the striker associated with each rear door is typically mounted to a C pillar of the body. Accordingly, there is an independent opening/entrance to the interior of the vehicle associated with each of the front and rear doors. There remains a need for improvements to door assemblies.

### SUMMARY OF THE DISCLOSURE

According to an aspect of the disclosure, a door assembly for a vehicle includes a body that has an A pillar toward a front of a body of the vehicle, a C pillar toward a rear of the body. A cant rail extends between a top of the A pillar and a top of the C pillar, and a rocker rail extends between a bottom of the A pillar and a bottom of the C pillar. A front door is moveably connected to the A pillar along a front connector, and has a front B pillar region spaced from the front hinge. A rear door is moveably connected to the C pillar along a rear connector, and has a rear B pillar region spaced from the rear connector. At least one latch assembly is coupled to at least one of the cant rail and the rocker rail, or at least one of the front B pillar region of the front door or the rear B pillar region of the rear door. At least one striker is coupled to at least one of the cant rail and the rocker rail, or at least one of the front B pillar region of the front door or the rear B pillar region of the rear door, and is configured to be coupled with the at least one latch assembly to hold at least one of the front and rear doors in a closed position.

According to another aspect of the disclosure, a door assembly for a vehicle includes a body that has an A pillar toward a front of a body of the vehicle, a C pillar toward a rear of the body. A cant rail extends between a top of the A pillar and a top of the C pillar, and a rocker rail extends between a bottom of the A pillar and a bottom of the C pillar. A front door is moveably connected to the A pillar along a front connector, and has a front B pillar region spaced from the front connector. A rear door is moveably connected to the C pillar along a rear connector, and has a rear B pillar region spaced from the rear connector. The front and rear doors are moveable into a closed position in which the front B pillar region of the front door and the rear B pillar region of the rear door overlie one another to close an interior of the body of the vehicle.

According to another aspect of the disclosure, a door assembly for a vehicle includes a body that has an A pillar toward a front of a body of the vehicle, a C pillar toward a rear of the body, a cant rail that extends between a top of the A pillar and a top of the C pillar, and a rocker rail that extends between a bottom of the A pillar and a bottom of the C pillar. A front door is pivotally connected to the A pillar along a front connector, and has a front B pillar region spaced from the front connector. A rear door is pivotally connected to the C pillar along a rear connector, and has a rear B pillar region spaced from the rear connector. A latch assembly is coupled to the cant rail. A front door striker is located at a top of the front B pillar region. The front door striker is configured to be latched to the latch assembly for selectively holding the front door in a closed position. A rear door striker is located at a top of the rear B pillar region. The rear door striker is configured to be latched to the latch assembly for selectively holding the rear door in a closed position.

Because the B pillar is essentially built into the doors via the B pillar regions rather than being part of the vehicle's body, the front and rear doors collectively open to a large unobstructed side opening for unhindered front and rear occupant ingress and egress. The assembly is also simple in design and inexpensive to make and provides effective safety and sealing capabilities.

### BRIEF DESCRIPTION OF THE DRAWINGS

These and other advantages of the present disclosure will be more readily understood by reference to the following description in combination with the accompanying drawings wherein:

FIG. 1 is a perspective view of a door assembly for a vehicle according to an aspect of the disclosure;

FIG. 2 is a side, perspective view of a latch assembly mounted to a cant rail of the door assembly;

FIG. 3 is a side view of an arrangement of strikers of the door assembly;

FIG. 4 is a perspective, exploded view of a latch housing and cant rail of the latch assembly;

FIG. 5 is a perspective view of the latch housing and cant rail;

FIG. 6 is a perspective, exploded view of the latch housing, cant rail and front and rear latches of the latch assembly;

FIG. 7 is a perspective view of the latch housing, cant rail and front and rear latches of the latch assembly;

FIG. 8 is a perspective view of the latch assembly, illustrating an arrangement of bulkheads for providing load management;

FIG. 9 is a perspective view of door latches of the door assembly;

FIG. 10 is a magnified view of the door latches of FIG. 9;

FIG. 11 is a perspective view of rocker mounted strikers of the door assembly;

FIG. 12 is a perspective, exploded view of an alternate rocker rail mounted latch assembly;

FIG. 13 is a perspective view of the alternate rocker rail mounted latch assembly;

FIG. 14A is a perspective view of the door assembly, illustrating a location of a rear hinge;

FIG. 14B is a magnified view of the location of the rear hinge;

FIG. 15A is a perspective view of the rear hinge;

FIG. 15B is a perspective view of the rear hinge coupled to the body;

FIG. 16 is a perspective view of a rear quarter panel covering the second hinge; and

FIG. 17 is a perspective, exploded view of the door assembly, illustrating an arrangement of seals.

### DETAILED DESCRIPTION OF THE ENABLING EMBODIMENTS

Example embodiments will now be described more fully with reference to the accompanying drawings. In general, the subject embodiments are directed to a door assembly 10 for a vehicle. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

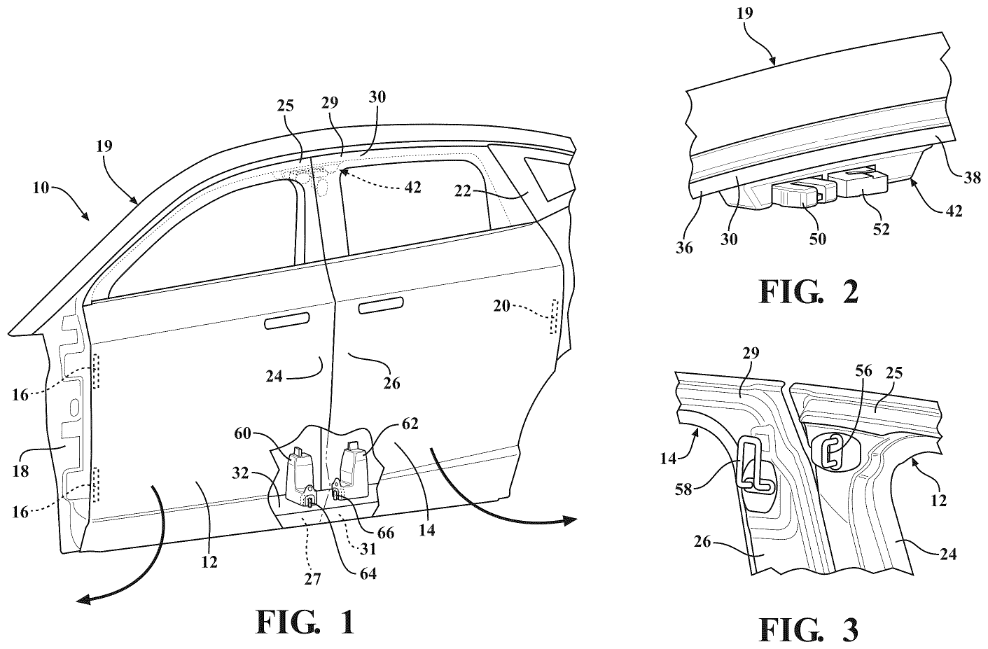

Referring to the figures, wherein like numerals indicate corresponding parts throughout the several views, embodiments of a door assembly 10 for a vehicle are provided. With reference to FIG. 1, the door assembly 10 provides a front door 12 and rear door 14 on both sides of a vehicle arranged in a “coach” style configuration in which the front and rear doors 12, 14 open in opposite directions relative to one another rather than in the same direction as one another as with conventional vehicles. More particularly, on each side, the front door 12 opens in a conventional manner along a front connector 16, like front hinge 16, positioned along an A pillar 18 of a body/frame 19 of the vehicle, and the rear door 14 opens in a “front to back” direction along a rear connector 20, like rear hinge 20, along a C pillar 22. The body 19 does not have a B pillar—rather an edge the front door 12 has a front B pillar region 24 and an edge of the rear door 14 has a rear B pillar region 26, thus effectively defining a B pillar along the doors 12, 14 rather than as part of the body 19. The front B pillar region 24 extends between a top segment 25 and a bottom segment 27. Likewise, the rear B pillar region 26 extends between a top segment 29 and a bottom segment 31. Accordingly, when the doors 12, 14 are opened, a large door opening 28 to the interior of the vehicle is provided with no B pillar in the way. The front and rear doors 12, 14 are configured to be moveable independently of one another in a pivoting and/or translating manner.

In further detail, as set forth in FIG. 1, the body 19 of the vehicle includes the A pillar 18 toward a front of the body 19, and the C pillar 22 toward a rear of the body 19. The body 19 has a cant (upper) rail 30 that extends between a top of the A pillar 18 and a top of the C pillar 22. The body 19 also has a rocker rail 32 that extends between a bottom of the A pillar and a bottom of the C pillar. The cant rail 20, A pillar 18, C pillar 22 and rocker rail 32 together define the door opening 28 therebetween through which passengers may access the interior of the vehicle.

The front and rear doors 12, 14 are each moveable between an open position and a closed position. While in the open positions, the B pillar regions 24, 26 of the doors 12, 14 are spaced from the body 19, and when in the closed positions, as shown in FIG. 1, the B pillar regions 24, 26 of the doors 12, 14 are positioned adjacent to one another and against the body 19. While in the closed positions, the front and rear doors 12, 14 are configured to seal along the B pillar regions 14, 16 relative to one another, such as via an arrangement of seals 90, 92, and/or via an overlap of one of the B pillar regions 24, 26 over the other.

Steel components are used to construct the B pillar regions 24, 26 of the door 12, 14 to provide strength and rigidity. Furthermore, the front and rear doors 12, 14 may be configured to include side impact beams and other reinforcement components to distribute input loads and tie the overall door 12, 14 structure together for side crash scenarios, and also to serve as striker and latch mounting points.

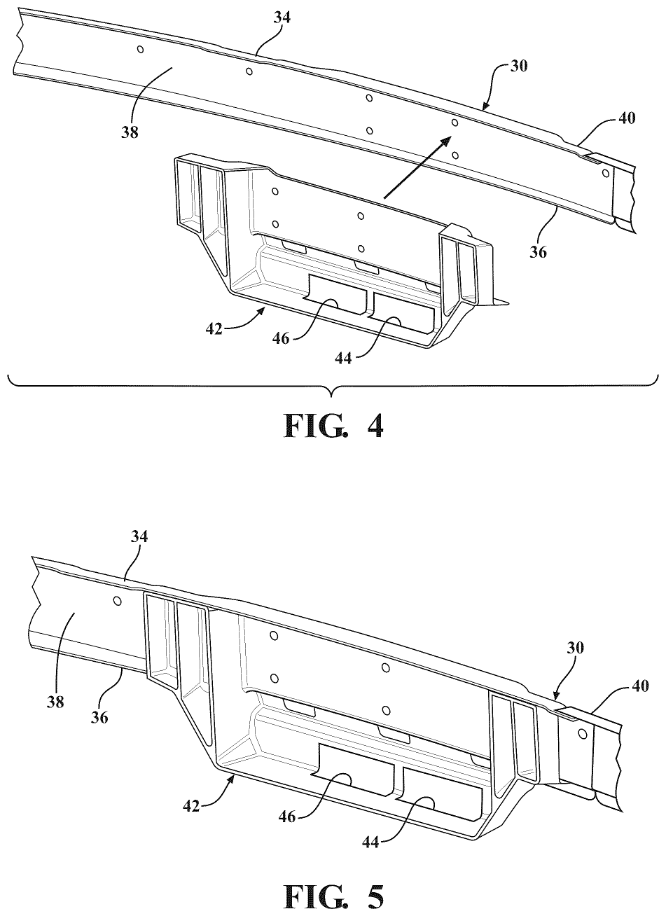

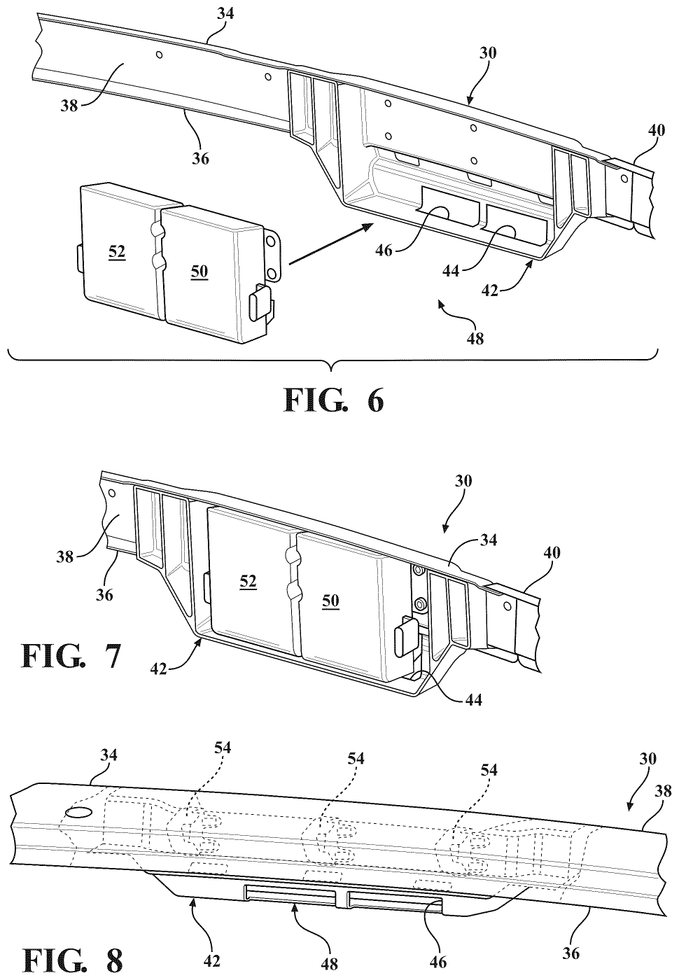

As best shown in FIGS. 2 and 4-8, the cant rail 30 has a top surface 34, a bottom surface 36, an inside surface 38 facing the interior of the vehicle, and an outside surface 40 facing outside of the vehicle. A latch assembly 48 is connected to the cant rail 30. According to the shown embodiment, latch assembly 48 is connected to the bottom surface 36 of the cant rail 30. The latch assembly 48 includes a latch housing 42 that has a front opening 44 and a rear opening 46 adjacent to the outside surface of the cant rail 30. The front and rear openings 44, 46 are positioned adjacent to one another. The latch housing 42 may be made via a casting process or the like. The latch assembly 48 also has a front panel latch 50 that protrudes through the front opening 44 of the latch housing 42 in alignment with the front B pillar region 24 of the front door 12 when the front door 12 is in the closed position. The latch assembly 48 also has a rear panel latch 52 that protrudes through the rear opening 46 of the latch housing 42 in alignment with the rear B pillar region 26 of the rear door 14 when the rear door 14 is in the closed position. As shown in FIG. 8, reinforcing bulkheads 54 may be provided along the latch housing 42 to provide latch load input management.

With reference to FIG. 3, a front door striker 56 is located at the top segment 25 of the front B-pillar region 24 of the front door 14. The front door striker 56 is configured to be latched to the front panel latch 50 for selectively securing the front door 14 in the closed position. Similarly, a rear door striker 58 is located at the top segment 29 of the rear B-pillar region 26 of the rear door 14. The rear door striker 58 is configured to be latched to the rear panel latch 52 for selectively securing the rear door 14 in the closed position. The front and rear door strikers 56, 58 may have various shapes and sizes for fitting with different configurations of the front and rear panel latches 50, 52.

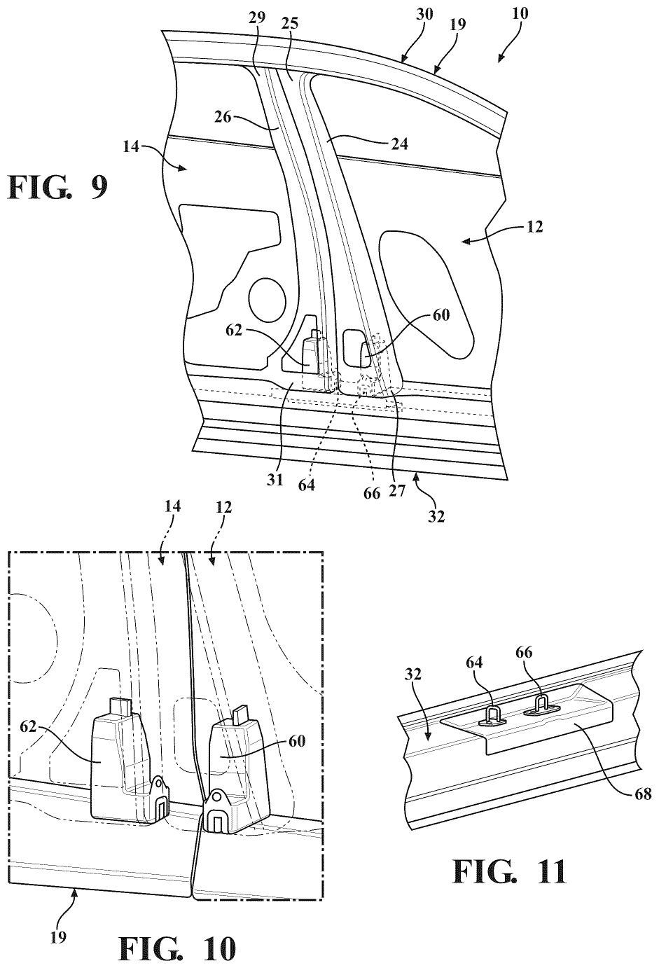

With reference to FIGS. 1 and 9-10, a front door latch 60 is connected to the bottom segment 27 of the front B-pillar region 24 of the front door 12. Likewise, a rear door latch 62 is connected to a bottom segment 31 of the rear B-pillar region 26 of the rear door 14. As shown in FIGS. 1 and 11, a front rocker striker 64 is positioned on the rocker rail 32 in alignment with the front door latch 60 when the front door 12 is in the closed position. The front rocker striker 64 is configured to be latched to the front door latch 60 for further selectively securing the front door 12 in the closed position. A rear rocker striker 66 is positioned on the rocker rail 32 adjacent to the front rocker striker 64 and in alignment with the rear door latch 62 when the rear door 14 is in the closed position. The rear rocker striker 66 is configured to be latched to the rear door latch 62 for further selectively securing the rear door 14 in the closed position. A mounting structure 68 of a material such as metal is provided on the rocker rail 32 for reinforcing the front and rear rocker strikers 64, 66.

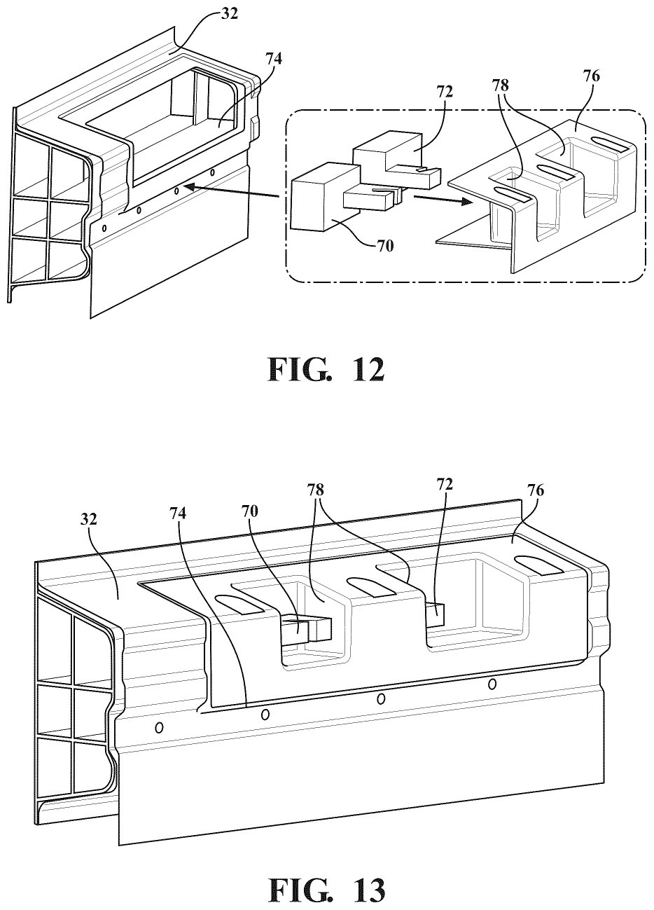

As shown in FIGS. 12-13, in an alternative arrangement, instead of having an arrangement of front and rear rocker strikers 64, 66 on the rocker rail 32, a front rocker latch 70 and a rear rocker latch 72 may be coupled to the rocker rail 32, and associated front and rear lower strikers (not shown) can be mounted at bottom portions of the B-pillar region 24, 26 of the front and rear doors 12, 14. More particularly, as shown in FIG. 12, under this arrangement, the rocker rail 32 defines a latch pocket 74 which receives a latch body 76. The latch body 76 defines two latch channels 78 adjacent to one another. The front rocker latch 70 and a rear rocker latch 72 extend through the latch channels 78. The front rocker latch 70 is aligned with the front lower striker and the rear rocker latch is 72 aligned with the rear lower striker to provide latching of the front and rear doors 12, 14 in their closed positions.

According to other embodiments, other arrangements/combinations of strikers and latches may be provided on the front and rear doors 12, 14 and cant and rocker rails 30, 32.

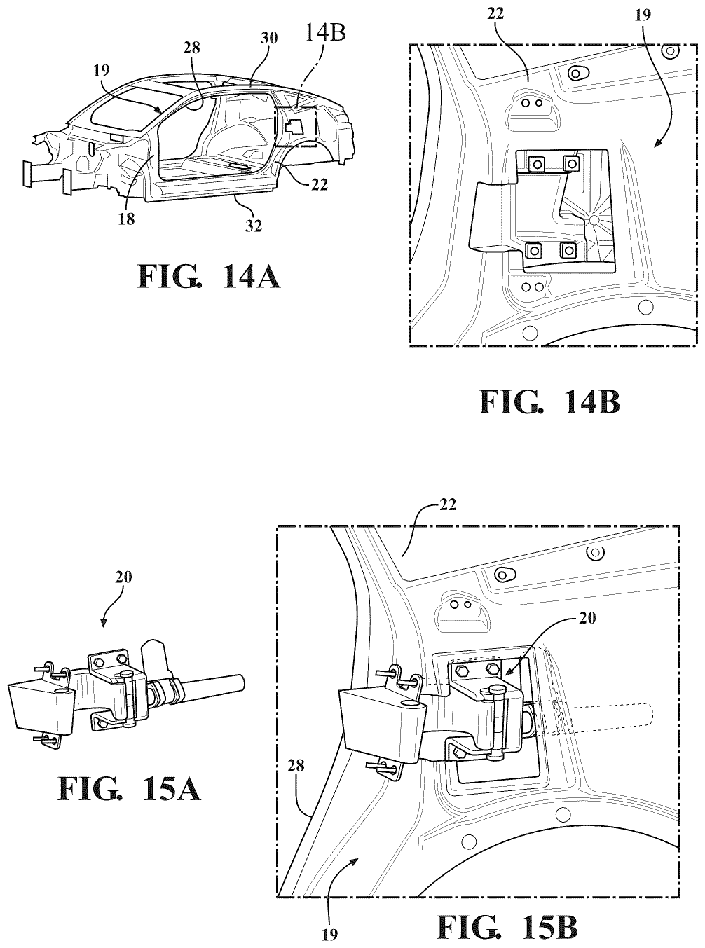

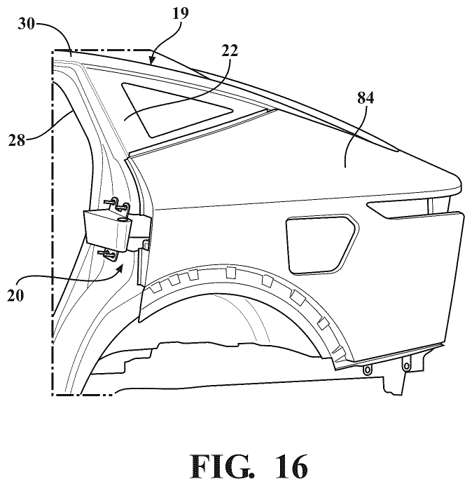

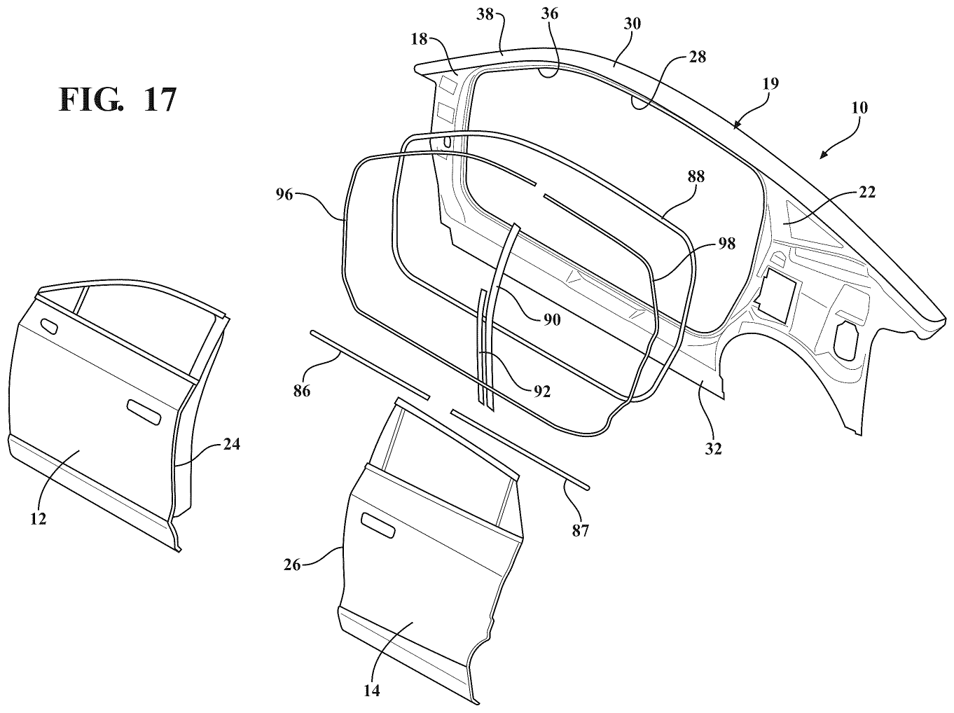

According to embodiments, movement of the front door 12 includes conventional pivoting along the front hinge 15 which is positioned at a fixed location along front hinges 16. As shown in FIGS. 14A-16, the rear connector 20 is configured to not just open the rear door 14, but also to translate the rear door outwardly away from the body 19 and rearwardly toward the rear of the body 19 prior to pivoting the rear door 14. This disengages an arrangement of B pillar seals 80, 82 (discussed below) of the front and rear doors 12, 14 from one another to unseal the gap between the front and rear doors 12, 14, and to provide space for the rear door 14 to pivot. The rear connector 20 is configured to be coupled to the body 19 at a location behind the C pillar 22. A rear quarter panel 84 is configured to cover a majority of the rear hinge 20.

As shown in FIG. 17 an arrangement of seals are configured to seal the front and rear doors 12, 14 when in the closed positions. Several layers of seals are provided to provide redundant noise vibration, harshness (NVH) reduction and water tightness.

First, at least one rocker strip seal 86 is attached to the front and rear doors 12, 14, respectively in alignment with the rocker rail 32, and are configured to seal bottoms of the front and rear doors 12, 14 relative to the rocker rail 32. Furthermore, a weather strip seal 88 is arranged along the cant rail 30, the A pillar 18, the C pillar 22 and the rocker rail 32 such that it surrounds the opening to the interior of the vehicle.

Two seals 90, 92 are positioned against the rear B pillar region 26 of the rear door 14. More particularly, an inner pillar seal 90 extends along a lower segment of the rear B pillar region 26 and a center pillar seal 92 extends along a full length of the B pillar region 26 along a hem flange of the rear door 14 to contact a hem flange of the front door 12. These seals may be applied directly to the rear door 14 with a tape adhesive. Other methods may be used to secure the seals 90, 92.

Furthermore, a front strip seal 96 is arranged along the A-pillar 18 region, the cant rail 30 and the rocker rail 32 in alignment with the front door 12 for sealing these regions of the front door 12 relative to the body 19. Furthermore, a rear strip seal 98 is arranged along the C-pillar 22 region, the cant rail 30 and the rocker rail 32 in alignment with the rear door 14 for sealing these regions of the rear door 14 relative to the body 19.

In view of the above, three levels of sealing are provided—a primary sealing arrangement comprised of the rock and weather strip seals 86, 88, a secondary sealing arrangement comprised of the inner, center and outer pillar seals 90, 92, and a third sealing arrangement comprised of the front and rear strip seals 96, 98.

In view of the foregoing, the combination of both door openings together with no B pillar on the body 19 provides a large unobstructed side opening for unhindered front or rear occupant ingress and egress. The assembly 10 provides door hinge and latching system with a B pillar integrated into the doors 12, 14 which provides effective safety and sealing capabilities. The assembly 10 may use high strength stamped materials, extrusions and castings.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in any embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A door assembly for a vehicle, comprising:
a body having an A pillar toward a front of a body of the vehicle, a C pillar toward a rear of the body, a cant rail extending between a top of the A pillar and a top of the C pillar, and a rocker rail extending between a bottom of the A pillar and a bottom of the C pillar;
a front door moveably connected to the A pillar along a front connector, and having a front B pillar region spaced from the front hinge;
a rear door moveably connected to the C pillar along a rear connector, and having a rear B pillar region spaced from the rear connector;
at least one latch assembly coupled to at least one of the cant rail and the rocker rail, or at least one of the front B pillar region or the rear B pillar region; and
at least one striker coupled to at least one of the cant rail and the rocker rail, or at least one of the front B pillar region or the rear B pillar region, and configured to be coupled with the at least one latch assembly to hold at least one of the front and rear doors in a closed position.

2. The door assembly as set forth in claim 1, wherein the at least one latch assembly is coupled to the cant rail, wherein the latch assembly includes an upper front panel latch aligned with the front B-pillar region of the front door when the front door is in a closed position, wherein the latch assembly includes an upper rear panel latch aligned with the rear B-pillar region of the rear door when the rear door is in the closed position, wherein the at least one striker includes an upper front striker coupled to a top segment of the front B pillar region of the front door for being coupled with the front panel latch when the front door is closed, and an upper rear striker coupled to a top segment of the rear B pillar region of the rear door for being coupled with the rear panel latch when the rear door is closed.

3. The door assembly as set forth in claim 2, wherein the cant rail has a top surface and a bottom surface opposite the top surface, wherein the at least one latch assembly has a latch housing coupled to the bottom surface of the cant rail, the latch housing having a front opening and a rear opening positioned adjacent to one another, wherein the upper front panel latch extends through the front opening of the latch housing, and wherein the upper rear panel latch extends through the rear opening of the latch housing.

4. The door assembly as set forth in claim 1, wherein the at least one latch assembly is coupled to the rocker rail, wherein the latch assembly includes a front panel latch aligned with a bottom portion of the front B-pillar region of the front door when the front door is in a closed position, wherein the latch assembly includes a rear panel latch aligned with a bottom portion of the rear B-pillar region of the rear door when the rear door is in the closed position, wherein the at least one striker includes a lower front striker coupled to the bottom segment of the front B pillar region of the front door for being coupled with the front panel latch when the door is closed, and a lower rear striker coupled to the bottom segment of the rear B pillar region of the rear door for being coupled with the rear panel latch when the rear door is closed.

5. The door assembly as set forth in claim 1, wherein the at least one latch assembly includes a front rocker latch coupled to the rocker panel in alignment with a lower portion of the front B-pillar region of the front door when the front door is in a closed position, and a rear rocker latch coupled to the rocker panel in alignment with a lower portion of the rear B-pillar region of the rear door when the rear door is in the closed position, wherein the at least one striker includes a lower front striker coupled to the bottom segment of the front B pillar region of the front door for being coupled with the front rocker latch when the front door is in the closed position, and a lower rear striker is coupled to the bottom segment of the B pillar region of the rear door for being coupled with the rear rocker latch when the rear door is in the closed position.

6. The door assembly as set forth in claim 1, wherein the at least one latch assembly includes a front door latch connected to a lower region of the front B pillar region of the front door, wherein the at least one latch assembly also includes a rear door latch connected to a lower region of the rear B pillar region of the rear door, wherein the at least one striker includes a front rocker striker positioned on the rocker rail in alignment with the front door latch when the front door is in a closed position, and a rear rocker striker positioned on the rocker tail in alignment with the rear door latch when the rear door is in a closed position.

7. The door assembly as set forth in claim 1, wherein the rear connector is configured to move the rear door outwardly away from the body and rearwardly toward the rear of the body, and to pivot the rear door.

8. The door assembly as set forth in claim 7, wherein the rear connector is positioned behind the C pillar.

9. A door assembly for a vehicle, comprising:
a body having an A pillar toward a front of a body of the vehicle, a C pillar toward a rear of the body, a cant rail extending between a top of the A pillar and a top of the C pillar, and a rocker rail extending between a bottom of the A pillar and a bottom of the C pillar;
a front door moveably connected to the A pillar along a front connector, and having a front B pillar region spaced from the front connector;
a rear door moveably connected to the C pillar along a rear connector, and having a rear B pillar region spaced from the rear connector; and
the front and rear door moveable into a closed position in which the front B pillar region of the front door and the rear B pillar region of the rear door overlie one another to close an interior of the body of the vehicle.

10. A door assembly as set forth in claim 9, wherein at least one latch assembly is coupled to at least one of the cant rail and the rocker rail, or the front door or the rear door, and at least one striker is coupled to at least one of the cant rail and the rocker rail, or the front door or the rear door, and wherein the at least one striker is connectable to the at least one latch assembly for holding at least one of the front door and the rear door in the closed position.

11. A door assembly as set forth in claim 10, wherein the at least one latch assembly or the at least one striker are coupled to at least one of the front B pillar region of the front door or the rear B pillar region of the rear door.

12. A door assembly as set forth in claim 9, wherein the at least one latch assembly is coupled to at least one of the cant rail and the rocker rail, or at least one of the front B pillar region or the rear B pillar region, and wherein at least one striker is coupled to at least one of the cant rail and the rocker rail, or at least one of the front B pillar region or the rear B pillar region, and configured to be coupled with the at least one latch assembly.

13. The door assembly as set forth in claim 12, wherein the at least one latch assembly is coupled to the cant rail, wherein the latch assembly includes an upper front panel latch aligned with the front B-pillar region of the front door when the front door is in a closed position, wherein the latch assembly includes an upper rear panel latch aligned with the rear B-pillar region of the rear door when the rear door is in the closed position, wherein the at least one striker includes an upper front striker coupled to a top segment of the front B pillar region of the front door for being coupled with the front panel latch when the front door is closed, and wherein an upper rear striker is coupled to a top segment of the rear B pillar region of the rear door for being coupled with the rear panel latch when the rear door is closed.

14. The door assembly as set forth in claim 13, wherein the cant rail has a top surface, a bottom surface opposite the top surface, an inside surface and an outside surface, wherein the at least one latch assembly has a latch housing coupled to the bottom surface of the cant rail, wherein the latch housing has a front opening and a rear opening positioned adjacent to one another, wherein the upper front panel latch extends through the front opening of the latch housing, and wherein the upper rear panel latch extends through the rear opening of the latch housing.

15. The door assembly as set forth in claim 9, wherein the at least one latch assembly is coupled to the rocker rail, wherein the latch assembly includes a front panel latch aligned with a bottom segment of the front B-pillar region of the front door when the front door is in a closed position, wherein the latch assembly includes a rear panel latch aligned with a bottom segment of the rear B-pillar region of the rear door when the rear door is in the closed position, wherein the at least one striker includes a lower front striker coupled to the bottom segment of the front B pillar region of the front door for being coupled with the front panel latch when the door is closed, and wherein a lower rear striker is coupled to the bottom segment of the rear B pillar region of the rear door for being coupled with the rear panel latch when the rear door is closed.

16. The door assembly as set forth in claim 9, wherein the at least one latch assembly includes a front rocker latch coupled to the rocker panel in alignment with a lower segment of the front B-pillar region of the front door when the front door is in a closed position, and a rear rocker latch coupled to the rocker panel in alignment with a lower segment of the rear B-pillar region of the rear door when the rear door is in the closed position, wherein the at least one striker includes a lower front striker coupled to the bottom segment of the front B pillar region of the front door for being coupled with the front rocker latch when the front door is in the closed position, and wherein a lower rear striker is coupled to the bottom segment of the B pillar region of the rear door for being coupled with the rear rocker latch when the rear door is in the closed position.

17. The door assembly as set forth in claim 9, wherein the at least one latch assembly includes a front door latch connected to a lower segment of the front B pillar region of the front door, wherein the at least one latch assembly also includes a rear door latch connected to a lower segment of the rear B pillar region of the rear door, wherein the at least one striker includes a front rocker striker positioned on the rocker rail in alignment with the front door latch when the front door is in a closed position, and wherein a rear rocker striker is positioned on the rocker rail in alignment with the rear door latch when the rear door is in a closed position.

18. The door assembly as set forth in claim 9, wherein the rear connector is configured to move the rear door outwardly away from the body and rearwardly toward the rear of the body, and configured to pivot the rear door.

19. A door assembly for a vehicle, comprising:
a body having an A pillar toward a front of a body of the vehicle, a C pillar toward a rear of the body, a cant rail extending between a top of the A pillar and a top of the C pillar, and a rocker rail extending between a bottom of the A pillar and a bottom of the C pillar;
a front door pivotally connected to the A pillar along a front connector, and having a front B pillar region spaced from the front connector;
a rear door pivotally connected to the C pillar along a rear connector, and having a rear B pillar region spaced from the rear connector;
a latch assembly coupled to the cant rail;
a front door striker located at a top of the front B pillar region, the front door striker configured to be latched to the latch assembly for selectively holding the front door in a closed position; and
a rear door striker located at a top of the rear B pillar region, the rear door striker configured to be latched to the latch assembly for selectively holding the rear door in a closed position.

20. The door assembly as set forth in claim 19, further including:
a front door latch connected to a bottom of the B-pillar region of the front door;
a rear door latch connected to a bottom of the B-pillar region of the rear door;
a front rocker striker on the rocker, the front rocker striker configured to be latched to the front door latch for further selectively holding the front door in the closed position; and
a rear rocker striker on the rocker adjacent to the front rocker striker, the rear rocker striker configured to be latched to the rear latch door for further selectively holding the rear door in the closed position.
